(19) United States
(12) Patent Application Publication
(10) Pub. No.: US 2004/0188349 A1
(43) Pub. Date: Sep. 30, 2004

(54) Earth atmospheric replenishment system ("EARS")

(76) Inventors: Jeffrey William Edgar, Banning, CA (US); Diana Rose Edgar, Banning, CA (US)

Correspondence Address: Jeffrey W. Edgar, 175 Santa Rita Place, Banning, CA, 92220, US

(21) Appl. No.: 10/401,456

(22) Filed: Mar. 28, 2003

(51) Int. Cl. B01D 11/00

(52) U.S. Cl. 210/634; 210/170; 210/747; 429/12; 429/13

(57) ABSTRACT

The Planet Earth is losing its breathable atmosphere. Water and oxygen are necessary to life. Populations are growing, and people are having a hard time finding enough places to live, It is, therefore, extremely important to do whatever can be done to both reduce and eliminate any practices resulting in pollution of our precious water and air, as well as maximizing the utility of any available Earth surface. Since the majority of the Earth's surface is covered by salt water/ocean, we are presented with a vast opportunity to have access to endless supplies of water, oxygen, and fuel—without pollution.

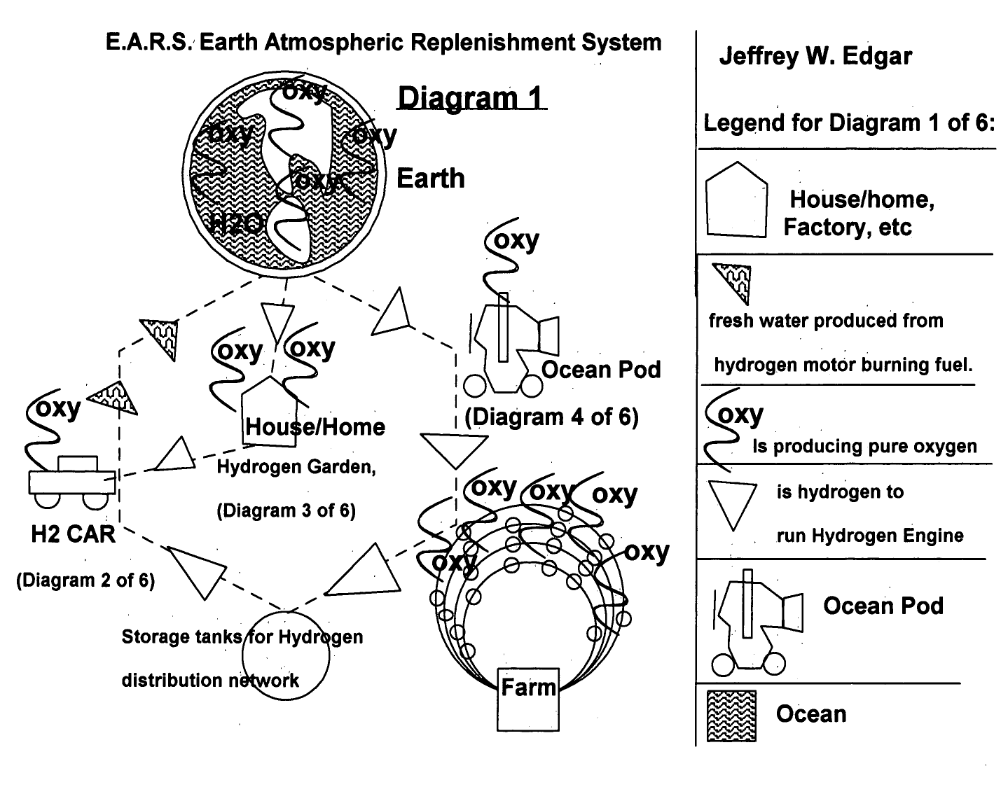

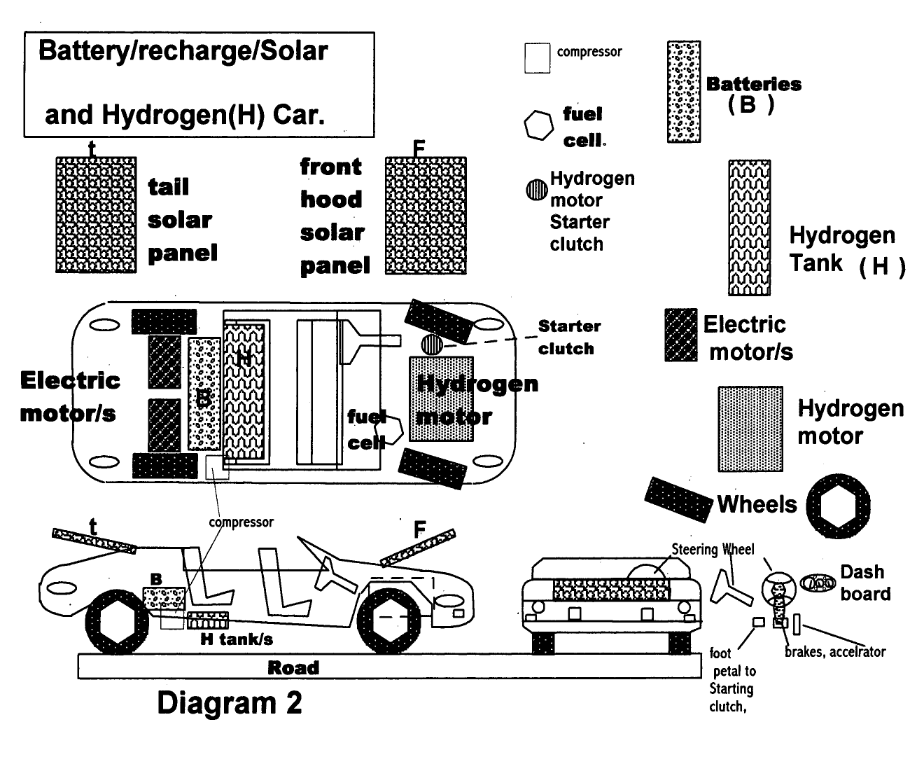

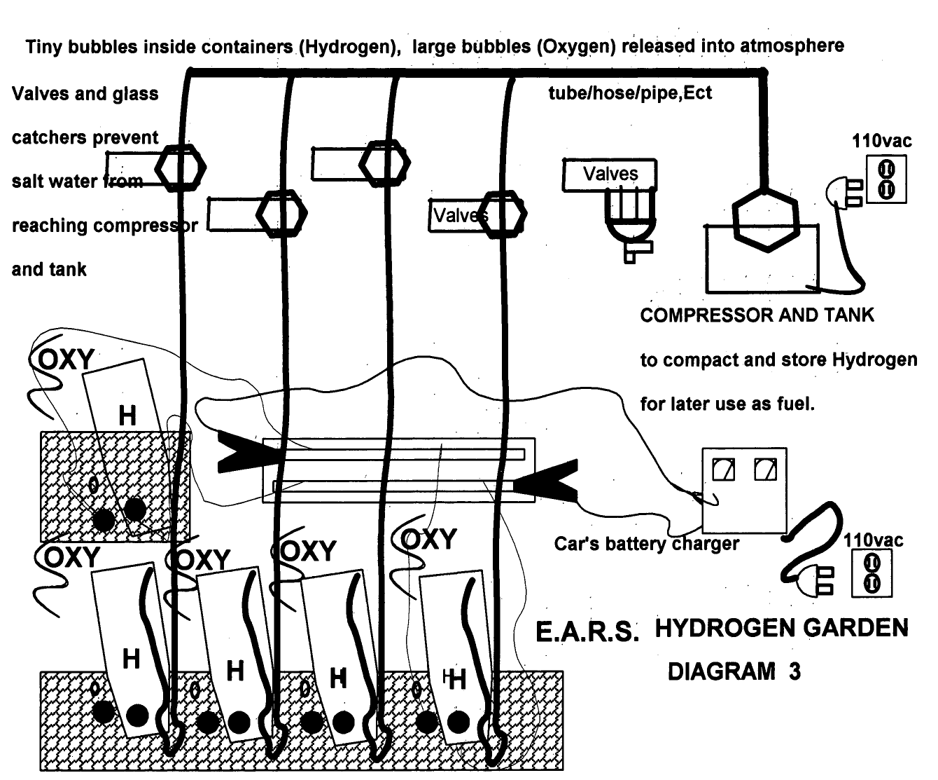

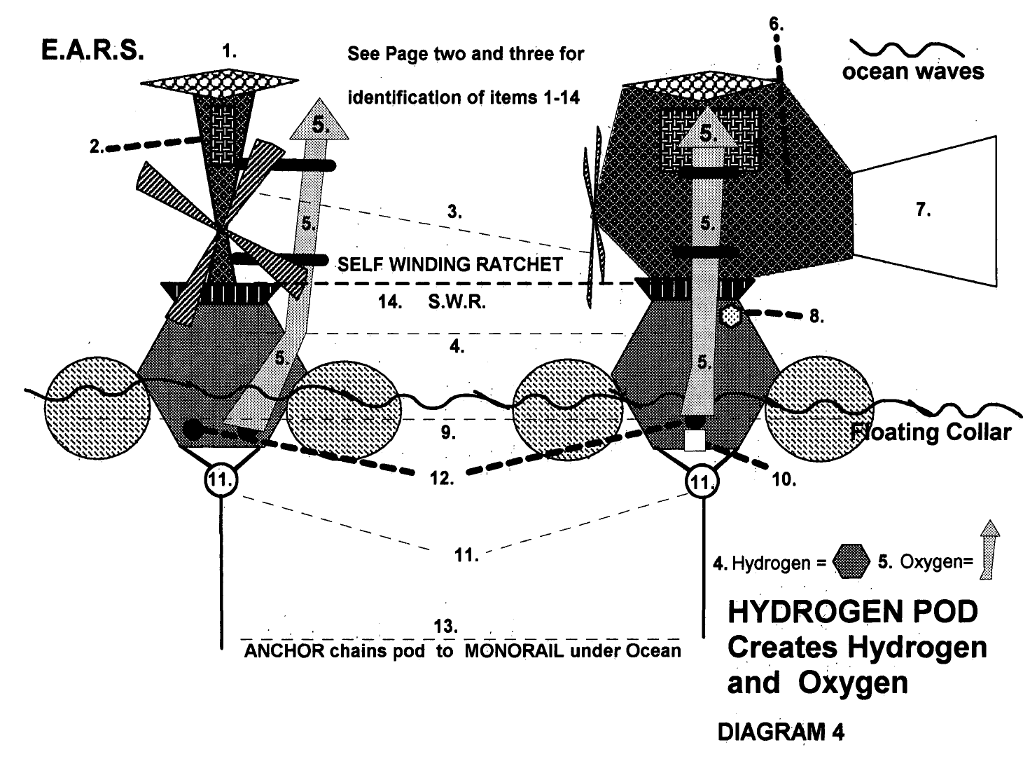

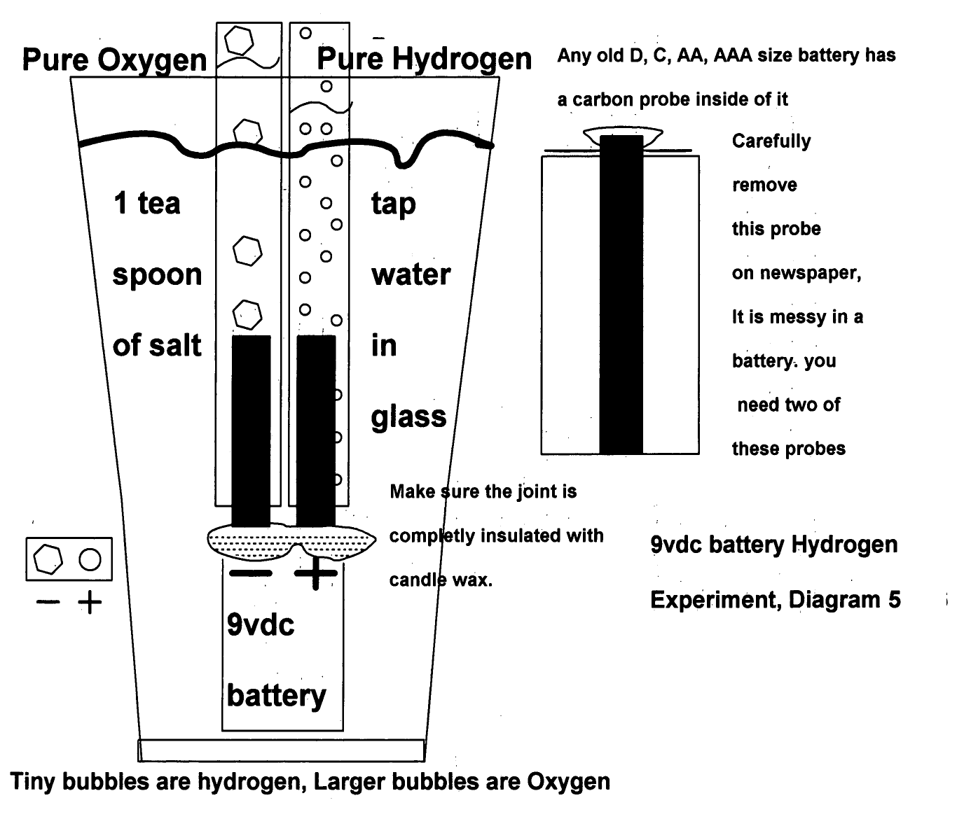

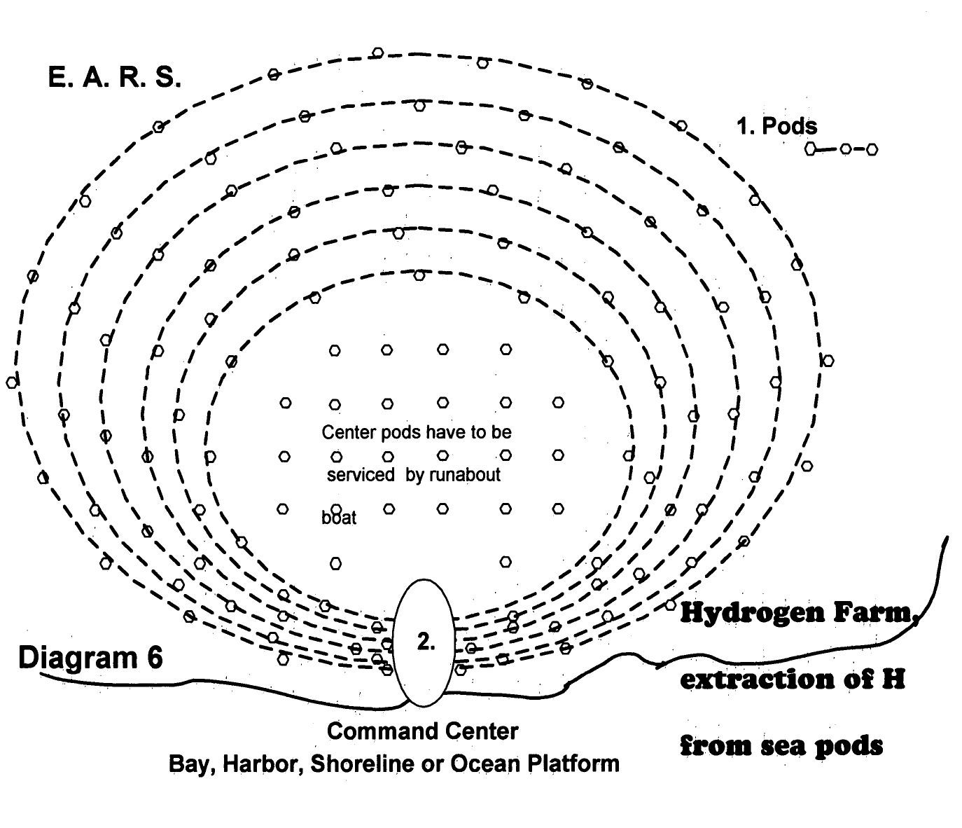

The Planet Earth is losing its breathable atmosphere. Water and oxygen are necessary to life. Populations are growing, and people are having a hard time finding enough places to live, It is, therefore, extremely important to do whatever can be done to both reduce and eliminate any practices resulting in pollution of our precious water and air, as well as maximizing the utility of any available Earth surface. Since the majority of the Earth's surface is covered by salt water/ocean, we are presented with a vast opportunity to have access to endless supplies of water, oxygen, and fuel—without pollution.

The above statement describes the purpose of this invention (“EARS” which stands for Earth Atmospheric Replenishment System). This system is actually made up of four separate components designed to work together to extract hydrogen (H2) from salt water; use the hydrogen fuel which is clean when burned, eliminating pollution (provides the energy to run the transportation devices as described in more detail in diagram #2 of 6); produce the bi-product of the burned fuel which is pure water; utilize as much Earth surface as possible to continue the extraction of hydrogen and oxygen from salt/sea water (diagram #4 of 6); create the option of portable atmosphere(s) which would enable humans to exist on other planets, moons, space stations; and provide the common person with the economic advantage of supplying himself with his own fuel (see “Hydrogen Garden”, diagram #3 of 6).

The four components of EARS are: (I) Solar electric/hydrogen powered car; (II) the Hydrogen Garden; (III) the Hydrogen Pod; and (IV) the Hydrogen Farm. If any of the components are missing, the system is not complete, because all the components work together to achieve this invention's purpose (see diagram 1 of 6).

The H2/Electric Car (see diagram 2 of 6) receives its power from solar/electric energy and hydrogen (“H2”), and has three motors, two of which use solar/electric power and the other utilizing H2. When a person would be ready to go for a ride in this new car, he would place the key in the “on” position, placing the gear shift in first gear or “reverse” depending on where the car was parked. Once he steps on the accelerator pedal, the car will move very quietly (similar to a golf cart). After the car has been on the road for a short time, gaining some speed, the driver would adjust the gearshift (just like in a car with automatic transmission) to second gear. Up to this point in time, the car has been running on solar/electric powered motors. A simple trip to the corner grocery store would require use of the solar/electric motors only. When the driver is going to take a trip which requires going on the freeway at higher speeds, the motion of the entire car provides enough inertia/force to engage the “starter clutch” which begins the running of the H2 engine. In “hydrogen drive” the alternator is charging all systems (the solar-powered batteries, the H2 fuel cell, which makes fuel for itself, and also vents oxygen constantly, as in the H2 garden, lights, H2 compressor/tank, and all other auxiliaries) to full capacity.

One huge advantage to the design of this car is that it is highly unlikely that one would ever have a serious enough mechanical problem with the car that would cause one to be stranded This is because even if one of the motors is malfunctioning, the driver can engage one of the other motors, thus able to drive the car to safety for repair, etc.

The two solar/electric motors are located on the axle of the back wheels. The H2 powered engine is just above and between the two front wheels (the engine can be 4, 6 or 8 cylinders). The car's original components are [1] battery bank, [2] tail and hood solar panels, [3] H2 compressor/tank, [4] H2 fuel cell, [5] starter clutch, [6] H2 engine, [7] solar-electric motors, and [8] “the road” (to catch and start the H2 motor in gear, while the car is running).

The “Hydrogen Garden” (diagram #3 of 6) is the means by which each person can produce his/her own fuel in his/her own yard. The garden could take up as little as three (3) square feet or be as large as the person wants to make it. If one were looking at such a garden, he would see a trough or perhaps several containers of salt water, and one or two clear plastic gallon bottles set upside-down in the salt water. Next to this water trough, would be a small H2 compressor/storage tank with clear plastic tubes running from each clear plastic bottle (inside, at the top) with enough length of plastic tubing to connect each bottle's H2 content to the compressor/tank. There are “sensors” (either like wires inside the clear bottles or an apparatus on the outside of the bottles) which can sense when water is just under the point where the plastic tube reaches inside the bottle to prevent water from entering the H2 compressor/tank (as water would destroy the compressor). Water level reaching the point of being “picked up” by the above-described sensors would turn on the carbon probe circuits (which are under each bottle) “telling” the circuits to again begin collecting more H2 into the bottle. Once the water has reached a level below the carbon probe, the circuit/connection is “broken”, and the H2 “collection” process will stop in the plastic bottle, as the bottle would be full of H2 at that point. Then the compressor (powered by being plugged into regular electrical outlet) comes on, and again transfers the H2 (that has been collected in the bottles) into the H2 compressor/tank There is a battery charger next to the trough, plugged into an electrical outlet; its two functions are supplying power to the carbon probes and charging up the car when parked and no sunlight available. To fill the car's fuel (H2) tank with the H2 that is in the garden's H2 compressor/tank, it is necessary to hook up a hose to the car's tank, attach the other end to the H2 compressor/tank, then adjust the setting on the compressor to “expulsion” rather than “storage” (as it would normally be when collecting H2 from the garden), and fill the fuel tank. Once the fuel tank is full, then the compressor can be readjusted and attached to the appropriate garden connections to resume its function in collecting more H2 for fuel to be stored for use later.

The “Hydrogen Pod” is a large fiber glass buoy, that floats on the ocean, and is designed to make and store hydrogen for commercial use. While venting pure oxygen into the atmosphere, the pod collects power from the sun and the wind. Each pod uses a track (much like a small roller coaster track, only at the bottom of the sea) to make its journey to and from home base. (See diagram #4 of 6). Many pods will make up the next component of EARS, the Hydrogen Farm (see below and diagram #6 of 6).

Each pod has a large floating collar (like a tire inner tube) and a universal joint, which enable it to turn/pivot freely in any direction and will not impede watercraft and itself not be harmed by watercraft or sealife. The pod has a sea filter so microlife will remain outside the pod, unharmed. The H2 collection chamber has quick disconnect for fast hydrogen drain. A self-winding ratchet (a mechanism much like what powers a self-winding watch) collects wave and wind forces to be used later on the farm to drive the pod tracks, providing energy to enable each pod to make its way around the entire track and back to home base.

The thirteen (13) parts of the Hydrogen Pod include: (1) solar cell/s, (2) windmill generator, (3) H2 collection polymer chamber (which contains the carbon probes and operates much like the mechanism in the clear plastic bottles of the Hydrogen Garden, as described above), (4) floating collar, (5) solar and wind circuits, (6) Oxygen vent, (7) wind appendage (works similar to the rudder on an airplane, allowing wind energy to push the pod around in the water so the windmill turns and the self-winding ratchet collects energy); (8) universal (free turning) joint, (9) locking quick disconnect H2 connector, (10) microlife filter, (11) track chain, (12) self-winding ratchet, and (13) carbon probes.

A simple way to understand how both the pod and garden “make” (extract) hydrogen, and vent oxygen from salt water is to do the following experiment, referring to diagram #5 of 6: Put a teaspoon of salt in an 8 oz clear glass of tap water, stir. Carefully remove and clean two positive carbon probes from old type (D, C, AA, or AAA) batteries. Fit a 9-volt dc battery with both probes on the negative. (−) and positive (+) steel terminals, insulate (cover) the steel terminals completely (as exposure to steel will contaminate the H2 and oxygen vapors) with a lot of nonconductive insulator (such as hot candle wax or hot glue from glue gun), while letting only both carbon probes be exposed. Now drop this assembly, battery down, into the glass of salted tap water. The small bubbles are pure hydrogen (−, negative probe), while the larger bubbles are pure oxygen (+, positive probe). Trap the small bubbles coming off the negative carbon probe (H2) by taking a small test tube full of salted water (held in the test tube by putting your thumb over the top of the test tube) upside-down over that probe. In only about ten minutes, that test tube will fill from bottom down to top, with Hydrogen. Now take the H2-filled test tube out of the water. Keeping it turned over at all times, so no H2 escapes, carefully put a lighted candle at the mouth of the test tube; watch and listen for a small “pop” of H2.

The “Hydrogen Farm” is made up of dozens of H2 pods for commercial collection of H2 (see above description of hydrogen pods; also, see diagram 6), These pods are chained to tracks and spaced about an eighth of a mile apart. They travel a full cycle, both starting and ending at the “base” (command center). This “base” starts at a platform or pier on ocean/sea, housing a warehouse, offices, personnel, repair shops, H2 storage facility, piping (hoses or “plumbing” necessary to transfer H2 from pod to compressor/tank to truck), truck depot and distribution dock, boat docks mainly for the small “runabout” boats, solar, wind, and other power sources (like wind farms, etc. so that there will be enough power to run lights, tracks,etc.). The “hydrogen pods” go around the entire track cycle, collecting/extracting H2, venting oxygen. This farm can cover a large volume area of ocean, but still can allow a ship any size, to navigate through it. Yet it provides a “security net” (sonar and/or other sensory security devices) for the harbor/shores close to its location.

The farm operates twenty-four hours every day, somewhat on its own (low maintenance), and would require staff to drain and distribute H2, as well as doing a maintenance check on the pods from the command center. It will be necessary for all operations of the farm to be equipped for various types of weather, hurricanes, turbulence, etc. Commercial tanker trucks would be taking the H2 which had been “harvested” from these farms to be distributed at commercial fuel stations.

Diagram 1 of 6, represents all four main componants of E. A. R. S. and demostrats how they relate to one another.

(Top of diagram) Earth is at least 75% ocean, and the Earth is running out of breathing air. Smog, global warming, populations, construction, etc, take up space that oxygen-venting vegetation should be filling. There was a time when this type of vegetation dominated Planet Earth. We need “The Earth Atmospheric Replenishment System” (E. A. R. S.) to replace pollution with vented oxygen and pure water.

The ocean pods sit in the ocean (lower right area), in the hydrogen farms making hydrogen and venting oxygen, for commercial use. The pods use the vast space provided by the ocean to vent oxygen. The storage tanks and distribution network work much like the “filling stations” to which drivers are already accustomed.

The hydrogen garden (middle area) is located in the individual's backyard, roof, factory, anywhere on land making hydrogen and venting oxygen for the individual's use.

The hydrogen car (left area) uses hydrogen fuel from both of the above-mentioned sources, and makes some of its own hydrogen fuel in its own fuel cell As in the other fuel-producing componants, this fuel cell also vents oxygen constantly. Burning hydrogen fuel results in pure water, not pollution.

f and t . The hood (f) and trunk lid (t) of the car are both actually functioning solar panels which each contains solar cells that feed power into the batteries and the fuel cell of the car. They should be latched carefully, treated with care,and kept clear and clean for best efficient collection of power.

B Batteries The batteries are heavy duty,deep cycle, high current. They move the electric motors and power the rest of the car in town, at slower speeds, just like a golf cart. The batteries also provide power to the fuel cell to make hydrogen fuel constantly.(24/7)

Electric motors The electric motors are on the rear wheels, they operate the car silently and at slower speeds, in and out of parking spaces and about town as long as the batteries are charged. Just like a golf cart, the car will be able to go up to 20 or 30 mph in electric mode only.

Hydrogen motor starter clutch The hydrogen motor starter clutch is used when the car has an automatic transmission and is going 30 mph facing level or downhill road in electric mode only. It will start the hydrogen motor while the car is moving. Pushing the pedal in will engage the hydrogen drive. The pedal is let out again when the hydrogen motor is running. Hydrogen motor starter clutch will not start the hydrogen motor while the car is standing still.

If the car has a standard shift transmission and clutch, then the Hydrogen motor starter clutch is-not needed. The car would be started by accelerating up to 30 mph (electric mode) and then Ipushing in and holding down the clutch, putting the car in second or third gear, then letting out the clutch. This technique is called “catching the car in gear.”

Hydrogen motor The Hydrogen motor runs the the front wheels of the car and is intended for taking the car on the freeway or long trip. This motor will take the car up to any speed. When the Hydrogen motor with its alternator is engaged, the batteries will be charged supplying the car with all its power needs, including the solar panels, blinkers, headlights, AC, fuel cell, etc. . . .

Hydrogen tank The Hydrogen tank stores all the car's hydrogen. It should be located, outside the passenger area, under the car for safety. It stores the hydrogen fuel made in the car, the hydrogen garden, or purchased from the commercial hydrogen fuel station.

Compressor The Compressor takes hydrogen from the fuel cell and/or from the hydrogen garden, compressing it to a very high density, storing it in the car's hydrogen tank.

Fuel cell The Fuel cell makes hydrogen constantly (24/7). The fuel cell uses the solar cells, the car batteries, the car charger, and/or any combination of these for power. The compressor (see above) then sends the hydrogen made to the tank (see above) to be stored. The fuel cell is also constantly venting clean oxygen into the atmosphere.

The rest of the car works just as a typical automobile. The steering wheel turns the front wheels. The brakes are the middle floor petal. The accelerator is the long floor petal on the right. The parking brakes are a foot or hand lever; headlights, turn signals, brake lights, windshield wipers, are available, also. Accessories such as air conditioning, power steering, etc. are optional just like the typical automobile.

What makes this hydrogen car better than all other cars? This car makes its own fuel (on the road and in the home hydrogen garden), vents oxygen into the atmosphere, thus there is no pollution created from the running of this invention. It is a vital part of the E. A. R. S. (Earth Atmospheric Replenishment System).

1. The Solar Cell Panel: provides the first of three sources of power to the pod.

2. The Circuits include Global Positioning System (GPS) and cellphone to permit electronic contact with the pod (checking telemetry of sensors, status of batteries, hydrogen collected etc.}.

3. The Windmill Generator, the second power source, gathers power from wind.

4. The Primary Chamber: collects/holds hydrogen.

5. The Oxygen Vent: vents the oxygen as the pod is operating.

6. The Secondary Chamber: keeps circuits protected from weather and sea.

7. The Wind Empennage turns the pod, so the windmill is facing directly into the wind.

8. The Quick Disconnect will allow fast, but secure access to hydrogen; a hose can be attached directly to it for transfer from the primary chamber to a compressor which will store the hydrogen in a high pressure tank on shore.

9. The Floating Collar keeps it all afloat.

10. The Filter: only lets sea water into the primary chamber, screening out sealife (plants and animals). When hydrogen is emptied out of the pod, the filter and batteries can be changed and/or the pod cleaned, if needed.

11. The Universal Joint allows the wind empennage to turn the pod in all directions of wind.

12. The Two Carbon Probes: when connected to solar cells, these probes attract hydrogen and oxygen bubbles.

13. The Anchor: chains pod to monorail under ocean, so the pod can make its way around the track to and from the command center (where pod is maintained and hydrogen collected).

14. The Self Winding Ratchet is the third power source, designed to collect and use mechanical energy gathered from ocean waves. It operates much like a self-winding watch; as the waves move the pod around, the ratchet is turned, causing tension to the mainspring (a metal ribbon) from a weight moving around in the gear system, thus collecting the energy from ocean waves. When a metal catch reaches a certain tension from the mainspring being wound tighter and tighter, it causes the release of the mainspring, thus causing a generator to begin running power to the batteries. This process simply repeats itself over and over.

1. we are presented with a vast opportunity to have access to endless supplies of water, oxygen, and fuel—without pollution. This claim is why we need “E.a.r.s.”

2. The above statement describes the purpose of this invention (“EARS” which stands for Earth Atmospheric Replenishment System). This claim is the title of E.ar.s.

3. This system is actually made up of four separate components designed to work together to extract hydrogen (H2) from salt water, use the hydrogen fuel. This claim is that E.A.R. System has four major components.

4. (provides the energy to run the transportation devices as described in more detail in diagram #2 of 6); This claim is E.A.R. System provides energy for transportation.

5. which is clean when burned, eliminating pollution This claim is E.A.R. System hydrogen fuel burns clean.

6. produce the bi-product of the burned fuel which is pure water; This claim is that the burning of E.A.R. System hydrogen fuel produces fresh water (drinking quality).

7. utilize as much Earth surface as possible to continue the extraction of hydrogen and oxygen from salt/sea water (diagram #4 of 6); This claim is EARS system can co-exist easily with humans (or other forms of life), without taking up additional space and not causing disruption in every day life.

8. create the option of portable atmosphere(s) which would enable humans to exist on other planets, moons, space stations; This claim is E.A.R. System can provide atmosphere to be where we would need to put it.

9. and provide the common person with the economic advantage of supplying himself with his own fuel (see “Hydrogen Garden”, diagram #3 of 6). This claim is E.A.R.S. garden is a means by which individuals can supply themselves with their own fuel.

10. A simple way to understand how both the pod and garden make” (extract) hydrogen, and vent oxygen from salt water is to do the following experiment, referring to diagram #5 of 6:
Put a teaspoon of salt in an 8 oz clear glass of tap water, stir. Carefully remove and clean two positive carbon probes from old type (D, C, AA, or AAA) batteries. Fit a 9-volt dc battery with both probes on the negative. (−) and positive (+) steel terminals, insulate (cover) the steel terminals completely (as exposure to steel will contaminate the H2 and oxygen vapors) with a lot of nonconductive insulator (such as hot candle wax or hot glue from glue gun), while letting only both carbon probes be exposed. Now drop this assembly, battery down, into the glass of salted tap water. The small bubbles are pure hydrogen (−, negative probe), while the larger bubbles are pure oxygen (+,positive probe). Trap the small bubbles coming off the negative carbon probe (H2) by taking a small test tube full of salted water (held in the test tube by putting your thumb over the top of the test tube) upside-down over that probe. In only about ten minutes, that test tube will fill from bottom down to top, with Hydrogen. Now take the H2-filled test tube out of the water. Keeping it turned over at all times, so no H2 escapes, carefully put a lighted candle at the mouth of the test tube; watch and listen for a small “pop” of H2. This claim is E.A.R. System can be demonstrated through performing the above-stated experiment.

11. The H2/Electric Car (see diagram 2 of 6) receives its power from solar/electric energy and hydrogen (“H2”), This claim is E.A.R.S.' car has two energy sources, solar/electric and hydrogen.

12. and has three motors, two of which use solar/electric power and the other utilizing H2. When a person would be ready to go for a ride in this new car, he would place the key in the “on” position, placing the gear shift in first gear or “reverse” depending on where the car was parked. Once he steps on the accelerator pedal, the car will move very quietly (similar to a golf cart). After the car has been on the road for a short time, gaining some speed, the driver would adjust the gearshift (just like in a car with automatic transmission) to second gear. Up to this point in time, the car has been running on solar/electric powered motors. A simple trip to the corner grocery store would require use of the solar/electric motors only. This claim is E.A.R.S. ' car has more than one engine and would run quietly.

13. When the driver is going to take a trip which requires going on the freeway at higher speeds, the motion of the entire car provides enough inertia/force to engage the “starter clutch” which begins the running of the H2 engine. This claim is E.A.R.S.' car hydrogen motor will start, once clutch is pushed in while driving highway speeds.

14. In “hydrogen drive” the alternator is charging all systems (the solar-powered batteries, the H2 fuel cell, This claim is E.A.R.S.' car alternator will recharge the car's energy resources as the car is running.

15. the H2 fuel cell, which makes fuel for itself This claim is E.A.R.S.' car always is making more of its own fuel, whether it is running or not.

16. and also vents oxygen constantly, This claim is E.A.R.S.' car vents oxygen all the time running or not.

17. as in the H2 garden, lights, H2 compressor/tank, and all other auxiliaries) to full capacity. This claim is E.A.R.S.' car has a compressor/tank for storage of hydrogen fuel, as in the H2 garden.

18. One huge advantage to the design of this car is that it is highly unlikely that one would ever have a serious enough mechanical problem with the car that would cause one to be stranded. This is because even if one of the motors is malfunctioning, the driver can engage one of the other motors, thus able to drive the car to safety for repair, etc. This claim is E.A.R.S.' car can run even if one or two of its three engines is malfunctioning.

19. The two solar/electric motors are located on the axle of the back wheels. This claim is E.A.R.S.' car can have two back motors on its axle.

20. The H2 powered engine is just above and between the two front wheels This claim is E.A.R.S.' car has one h2 engine in front.

21. (the engine can be 4, 6 or 8 cylinders). This claim is E.A.R.S.' car engine could be any size.

22. The car's original components are [1] battery bank, [2] tail and hood solar panels, [3] H2 compressor/tank, [4] H2 fuel cell, [5] starter clutch, [6] H2 engine, [7] solar-electric motors, and [8] “the road” (to catch and start the H2 motor in gear, while the car is running). This claim is E.A.R S.' car has the above-stated components.

23. The “Hydrogen Garden” (diagram #3 of 6) is the means by which each person can produce his/her own fuel in his/her own yard. This claim is E.A.R.S.' garden makes hydrogen fuel for use in the hydrogen car.

24. The garden could take up as little as three (3) square feet or be as large as the person wants to make it. This claim is E.A.R.S.' garden can be as big or small, as the owner wants.

25. If one were looking at such a garden, he would see a trough or perhaps several containers of salt water, and one or two clear plastic gallon bottles set upside-down in the salt water. This claim is E.A.R.S.' garden may appear as a trough (with salt water in it) with 1-2 clear plastic gallon bottles set upside down in the trough of salt water.

26. Next to this water trough, would be a small H2 compressor/storage tank This claim is E.A.R.S.' garden also has a compressor/storage tank in which to store the hydrogen fuel.

27. a small H2 compressor/storage tank with clear plastic tubes running from each clear plastic bottle (inside, at the top) with enough length of plastic tubing to connect each bottle's H2 content to the compressor/tank. This claim is E.A.R.S.' Garden has tubes from bottles to valves to compressor.

28. There are “sensors” (either like wires inside the clear bottles or an apparatus on the outside of the bottles). Which can sense when water is just under the point where the plastic tube reaches inside the bottle to prevent water from entering the H2 compressor/tank (as water would destroy the compressor). Water level reaching the point of being “picked up” by the above-described sensors would turn on the carbon probe circuits (which are under each bottle) “telling” the circuits to again begin collecting more H2 into the bottle. Once the water has reached a level below the carbon probe, the circuit/connection is “broken”, and the H2 “collection” process will stop in the plastic bottle, as the bottle would be full of H2 at that point. Then the compressor (powered by being plugged into regular electrical outlet) comes on, and again transfers the H2 (that has been collected in the bottles) into the H2 compressor/tank This claim is E.A.R.S.' garden has sensors stopping saltwater from destroying the compressor.

29. and itself not be harmed by watercraft This claim is E.A.R.S.' pods will not impede watercraft, nor will watercraft impede functioning of the pods.

30. There is a battery charger next to the trough, plugged into an electrical outlet; This claim is E.A.R.S.' garden uses the car's battery charger, which is plugged into a regular electrical outlet.

31. its two functions are supplying power to the carbon probes and charging up the car when parked and no sunlight available. This claim is E.A.R.S.' garden uses the car's battery charger to supply energy, so the garden can produce hydrogen fuel.

32. To fill the cars fuel (H2) tank with the H2 that is in the garden's H2 compressor/tank, it is necessary to hook up a hose to the car's tank; attach the other end to the H2 compressor/tank; then adjust the setting on the compressor to “expulsion” rather than “storage” (as it would normally be when collecting H2 from the garden); and fill the fuel tank. This claim is E.A.R.S.' car can be refueled with H2 directly from the garden's H2 compressor tank.

33. The “Hydrogen Pod” is a large fiber glass buoy, that floats on the ocean, and is designed to make and store hydrogen for commercial use. This claim is E.A.R.S.' pod floats on seawater, thereby producing and storing hydrogen fuel for commercial use.

34. While venting pure oxygen into the atmosphere, This claim is E.A.R.S.' pod vents oxygen all the time.

35. the pod collects power from the sum This claim is E.A.R.S.' pod gets power from the sun.

36. and the wind. This claim is E.A.R.S.' pod gets some power from wind.

37. A self-winding ratchet (a mechanism much like what powers a self-winding watch) collects wave and wind forces to be used later on the farm to drive the pod. This claim is E.A.R.S.' pod's self-winding ratchet collects energy from wave forces.

38. Each pod uses a track (much like a small roller coaster track, only at the bottom of the sea) to make its journey to and from home base. (See diagram #4 of 6). This claim is E.A.R.S.' pods have a track on sea bottom which guides them around a large ocean surface, enabling each pod to emptied of the H2 at the home base.

39. only at the bottom of the sea) to make its journey to and from home base. (See diagram #4 of 6). Many pods will make up the next component of EARS, the Hydrogen Farm (see below and diagram #6 of 6). This claim is E.A.R.S.' farm should have many pods.

40. Each pod has a large floating collar (like a tire inner tube) This claim is E.A.R.S.' pod floats because of its large floating collar.

41. and a universal joint, which enable it to turn/pivot freely in any direction This claim is E.A.R.S.' pod has a universal joint, which enables it to spin or move freely in any direction.

42. and will not impede watercraft This claim is E.A.R.S.' Pod will not hinder ships as they are being navigated through a farm.

43. The pod has a sea filter so microlife will remain outside the pod, unharmed. This claim is E.A.R.S.' pod's microlife filter will protect microlife.

44. This claim is E.A.R System H2 can be transported by rail, boat, plane, etc . . .

45. The H2 collection chamber has quick disconnect for fast hydrogen drain. This claim is E.A.R.S.' pod should be drained quickly with the help of a quick disconnect.

46. The thirteen (13) parts of the Hydrogen Pod include: (1) solar cell/s, This claim is E.A.R.S.' pod has solar cells.

47. (2) windmill generator, This claim is E.A.R.S.' pod has a windmill generator.

48. (3) H2 collection polymer chamber This claim is E.A.R.S.' pod has an H2 collection polymer chamber.

49. (which contains the carbon probes) This claim is E.A.R.S.' pod has carbon probes.

50. (5) solar and wind circuits, This claim is E.A.R.S.' pod has solar and wind circuits.

51. (6) Oxygen vent, This claim is E.A.R.S.' pod has an oxygen vent.

52. (7) wind appendage (works similar to the rudder on an airplane, allowing wind energy to push the pod around This claim is E.A.R.S.' pod has a wind appendage which allows wind to push pod around.

53. (11) track chain, This claim is E.A.R.S.' pod has a track chain.

54. The “Hydrogen Farm” is made up of dozens of H2 pods for commercial collection of H2 (see above description of hydrogen pods; also, see diagram 6), This claim is E.A.R.S.' farm is for commercial and industrial production of hydrogen fuel.

55. They travel a full cycle, both starting and ending at the “base” (command center). This “base” starts at a platform or pier on ocean/sea, housing a warehouse, offices, personnel, repair shops, H2 storage facility, piping (hoses or “plumbing” necessary to transfer H2 from pod to compressor/tank to truck), This claim is E.A.R.S.' farm should include a warehouse, offices, repair shops, storage facility.

56. truck depot and distribution dock, This claim is E.A.R.S.' farm has truck depot.

57. boat docks mainly for the small “runabout” boats, This claim is E.A.R.S.' farm has boat docks for small “runabout” boats.

58. Yet it provides a “security net” (sonar and/or other sensory security devices) for the harbor/shores close to its location. This claim is E.A.R.S.' farm can be a “security net”.

59. The farm operates twenty-four hours every day, This claim is E.A.R.S.' farm operates all the time.

60. and would require staff to drain and distribute H2, as well as doing a maintenance check on the pods from the command center. This claim is E.A.R.S.' farm needs a staff to service it.

61. It will be necessary for all operations of the farm to be equipped for various types of weather, hurricanes, turbulence, etc. This claim is E.A.R.S.' farm must be able to withstand all kinds of weather.

62. Commercial tanker trucks would be taking the H2 which had been “harvested” from these farms to be distributed at commercial fuel stations. This claim is E.A.R. System hydrogen can go anywhere by truck.

63. This claim is E.A.R.S. Pod Carbon probes are as available as batteries are, and last longer. All life on our planet is carbon based.

64. This claim is E.A.R.S. pod is not dangerous to sea life. If a pod sinks, it becomes a reef. The hydrogen will not stay in the water, unless trapped. Once the solar cells and generator are submerged, all power stops and the pod is dead weight.

65. This claim is E.A.R. System is a great advantage to the military, being able to produce their own fuel, wherever they travel, maintaining security of all areas.

66. This claim is E.A.R. System is following a Presidential order for the U.S.A. to switch to use of hydrogen fuel.

67. This claim is E.A.R. System is entitled to any and all government help, such as: grants and contracts. What will be needed to make E.A.R. System a reality are completion of patent process, financial backing, land, access to ocean areas, airspace, ocean platforms and beach areas, staff, buildings, labs, factories, technical assistance, etc. under H.R. 4138 Hydrogen Future Act of 1996(now public law 104-271).
